(19) United States
(12) Patent Application Publication
(10) Pub. No.: US 2005/0017219 A1
(43) Pub. Date: Jan. 27, 2005

(54) Dispersant compositions containing a diisobutyl ester of a dicarboxylic acid and a polyurethane-based dispersant

(76) Inventors: Ludwig Schieferstein, Ratingen (DE); Heinz-Guenther Schulte, Muelheim (DE); Manfred Gorzinski, Duesseldorf (DE); Christina Hirsch, Duesseldorf (DE)

Correspondence Address: COGNIS CORPORATION;PATENT DEPARTMENT, 300 BROOKSIDE AVENUE, AMBLER, PA, 19002, US

(21) Appl. No.: 10/492,039

(22) PCT Filed: Sep. 27, 2002
(86) PCT No.: PCT/EP02/10859

(30) Foreign Application Priority Data
Oct. 6, 2001 (DE) 101 49 384.3

(51) Int. Cl. B01F 3/00; C08K 3/00

(52) U.S. Cl. 252/363.5; 524/589

(57) ABSTRACT

Dispersant compositions are described which contain: (a) a carrier medium comprising a ternary mixture of diisobutyl esters of succinic acid, glutaric acid and adipic acid, the carrier medium present in an amount of from 10 to 80% by weight based on the composition; and (b) one or more polyurethane dispersants present in an amount of from 20 to 90% by weight based on the composition.

### FIELD OF THE INVENTION

This invention relates to dispersant compositions for paint formulations, these dispersant compositions being liquid and pourable at 25° C. and being based on a special carrier medium and a polyurethane-based dispersant.

Prior Art

Dispersants are used in paint manufacture largely for the following reasons:
a) to disperse the film former,
b) to disperse pigments and fillers and
c) to disperse other additives which may be present in paint formulations, for example hardening accelerators, thickeners, flow controllers, flatting agents, preservatives.

As the expert is aware, paint manufacturers generally seek to have the components used for the production of paint formulations available in a form which allows for easy handling. A major advantage in this regard is if a component is present in liquid rather than solid form and can be poured at room temperature (room temperature in the context of the present invention is understood to be a temperature of 25° C. This is routinely achieved by the use of solvents. In principle, suitable solvents are on the one hand water and, on the other hand, organic solvents. However, there are instances where, on the one hand, water is not suitable because it is unable satisfactorily to dissolve the dispersant or because the dispersant is not permanently stable in water and where, on the other hand, organic solvents are not suitable. The latter point is of increasing importance because organic solvents have become increasingly unattractive for environmental reasons so that substantial freedom from VOCs (volatile organic compounds) is desirable. Accordingly, there is a constant demand for dispersants to be presented in a form which is not attended by any of the above-mentioned disadvantages.

### DESCRIPTION OF THE INVENTION

The problem addressed by the present invention was to provide dispersant compositions which would consist of a carrier medium and one or more dispersants and which would satisfy the following conditions: the compositions would be liquid at 25° C., homogeneous, concentrated, pourable, stable in storage and substantially free from VOCs.

By “homogeneous” is meant that the dispersant is homogeneously dispersed in the carrier medium. By “concentrated” is meant that the composition contains at least 20% by weight of the dispersant, based on the composition as a whole. “Pourable” means that the Brookfield viscosity of the composition, as measured at 25° C./25 r.p.m., is below 50,000 mPas. “Stable in storage” is understood to mean that, even in the event of prolonged storage, the composition remains stable both chemically (no decomposition of the components) and in regard to consistency (no loss of homogeneity). “Substantially free from VOCs” is understood to mean that the composition contains hardly any volatile substances. This means in particular that the carrier medium of the composition is of low volatility.

In addition, the composition of the carrier medium should be such that no adverse interactions occur when the combination of carrier medium and dispersant is used for the production of a paint formulation where it inevitably comes into contact with film formers, pigments, fillers and/or paint additives.

The present invention relates to dispersant compositions for paint formulations which are liquid and pourable at 25° C. and which consist of
a) 10 to 80% by weight of a carrier medium in the form of one or more diisobutyl esters of C₄₋₆ dicarboxylic acids and
b) 20 to 90% by weight of one or more polyurethane dispersants for paint formulations.

It has surprisingly been found that the compositions according to the invention solve the problem stated above excellently in every respect. The compositions are liquid, homogeneous, pourable and stable in storage. They are also distinguished by substantial freedom from VOCs.

The VOC content of a composition can be determined by methods known to the relevant expert. In the context of the present invention, substantial freedom from VOCs is understood to mean a VOC value of less than 0.5% and preferably less than 0.2%, based on the composition as a whole. In the context of the present invention, the VOC content of a sample is determined in accordance with DIN 75201 (“Determination of the Fogging Behavior of Materials Used for the Interior Trim of Motor Vehicles”) using the following procedure: the sample is placed on the bottom of a lip-free glass beaker with fixed dimensions. The beaker is covered with an aluminium foil on which volatile constituents from the test specimen or the sample are able to condense. The aluminium foil is cooled. The beaker thus prepared is placed for 16 hours in a bath thermostat set to a test temperature of 100±0.3° C. The effect of the fogging deposit on the aluminium foil is quantitatively determined by weighing the foil before and after the fogging test. The VOC value is calculated in accordance with the following equation:
VOC value (%)=(A/B)*100
where
A is the weight of the fogging deposit (in g) and
B is the weight of the sample used (in g).

In addition, the compositions according to the invention are compatible with film formers, pigments, fillers and paint additives which are normally used in the production of paint formulations.

The carrier medium a) consists of one or more diisobutyl esters of C₄₋₆ dicarboxylic acids. The diisobutyl esters to be used may therefore be used individually or in admixture with one another.

Preferred dicarboxylic acids are succinic acid, glutaric acid and adipic acid.

Binary dicarboxylic acid mixtures suitable for use as component a) are succinic acid/glutaric acid, succinic acid/adipic acid and glutaric acid/adipic acid.

Particular preference is attributed to ternary mixtures of succinic acid, glutaric acid and adipic acid, particularly those use by the expert in the production of Nylon, for example ternary mixtures consisting of ca. 25% by weight succinic acid, 50% by weight glutaric acid and 25% by weight adipic acid.

The dispersant b) is a polyurethane. Any polyurethanes known to the relevant expert may be used. One embodiment is characterized by the use of polyurethanes known to the relevant expert which contain the following structural elements:
oligomeric caprolactone blocks started with linear C₆₋₁₈ alcohols or with amines containing additional tert.amine groups or alcohols,
amines substituted by tert.amine groups or alcohols,
oligomeric dihydroxy-terminated ethylene oxide blocks (as described in EP 154 678, for example, as particularly effective dispersants for organic paint systems).

The structural elements mentioned are reacted individually or in combination with polyfunctional, preferably tetrafunctional, polyisocyanates for the production of the polyurethanes.

In a preferred embodiment, the compounds to be used as component b) have a solubility of at least 20% by weight in a mixture consisting of 25% by weight of succinic acid diisobutyl ester, 50% by weight of glutaric acid diisobutyl ester and 25% by weight of adipic acid diisobutyl ester.

In addition, the dispersants b) suitable for the purposes of the invention may be used individually or in admixture with one another.

Suitable polyurethanes are, in particular, the nonvolatile polymeric active components of standard commercial products such as, for example, Disperbyk 163 (Byk Chemie) or Texaphor P60 and Texaphor P63 (Cognis Deutschland GmbH) which, in supply form, have hitherto been marketed exclusively in volatile organic solvents, such as xylene, butyl acetate or methoxypropyl acetate, and used in this form by the user.

The dispersants b) suitable for the purposes of the invention may be used individually or in admixture with one another.

The present invention also relates to the use of the above-described dispersant compositions in the production of paint formulations.

### EXAMPLES

### Substances Used

Texaphor P 60: block copolymer of oligocaprolactone, oligoethylene oxide and adhering terminal groups bearing t-amino groups (50% polymer solution in butyl acetate/xylene, a product of Cognis Deutschland GmbH)
Texaphor P 63: block copolymer of oligocaprolactones, long-chain alkyl groups and adhering terminal groups bearing t-amino groups (45% polymer solution in methoxypropyl acetate/butyl acetate, a product of Cognis Deutschland GmbH)
KE 1000: diisobutyl ester of a mixture of linear C₄₋₆ dicarboxylic acids (Cognis Deutschland GmbH)

### Dispersant Compositions

### Example 1

250.0 g Texaphor P 60 and 125.0 g KE 1000 were introduced into a 1-liter glass flask and heated to 100° C. in vacuo (150 mbar) in a rotary evaporator. After most of the solvent had been removed, a gentle stream of nitrogen was passed over the surface of the reaction mixture—while the vacuum of ca. 150 mbar was maintained—until weight was constant. Yield of product: 250.0 g. Characterization of the product: clear, light yellow composition of honey-like consistency, Brookfield viscosity (as measured at 20 r.p.m., 25° C., spindle 6): 42.4 Pas.

### Example 2

1111.1 g Texaphor P 63 and 500.1 g KE 1000 were introduced into a 1-liter glass flask and heated to 100° C. in vacuo (150 mbar) in a rotary evaporator. After most of the solvent had been removed, a gentle stream of nitrogen was passed over the surface of the reaction mixture—while the vacuum of ca. 150 mbar was maintained—until weight was constant. Yield of product: 1000.0 g. Characterization of the product: clear, light yellow composition of honey-like consistency, Brookfield viscosity (as measured at 20 r.p.m., 25° C., spindle 6): 7.0 Pas.

1-2. (Canceled)

3. A dispersant composition comprising:
(a) a carrier medium comprising a ternary mixture of diisobutyl esters of succinic acid, glutaric acid and adipic acid, the carrier medium present in an amount of from 10 to 80% by weight based on the composition; and
(b) one or more polyurethane dispersants present in an amount of from 20 to 90% by weight based on the composition.

4. The dispersant composition according to claim 3, wherein the one or more polyurethane dispersants comprises a polyurethane having a solubility at least 20% by weight in a mixture comprising 25% by weight of succinic acid diisobutyl ester, 50% by weight of glutaric acid diisobutyl ester and 25% by weight of adipic acid diisobutyl ester.

5. The dispersant composition according to claim 3, wherein the composition is substantially free from VOC's.

6. The dispersant composition according to claim 4, wherein the composition is substantially free from VOC's.

7. The dispersant composition according to claim 3, wherein the composition is liquid and pourable at 25° C.

8. The dispersant composition according to claim 4, wherein the composition is liquid and pourable at 25° C.

9. The dispersant composition according to claim 5, wherein the composition is liquid and pourable at 25° C.

10. The dispersant composition according to claim 6, wherein the composition is liquid and pourable at 25° C.

11. A dispersant composition comprising:
(a) a carrier medium comprising a ternary mixture of diisobutyl esters of succinic acid, glutaric acid and adipic acid, the carrier medium present in an amount of from 10 to 80% by weight based on the composition; and
(b) one or more polyurethane dispersants present in an amount of from 20 to 90% by weight based on the composition, wherein the one or more polyurethane dispersants comprises a polyurethane having a solubility at least 20% by weight in a mixture comprising 25% by weight of succinic acid diisobutyl ester, 50% by weight of glutaric acid diisobutyl ester and 25% by weight of adipic acid diisobutyl ester;
wherein the composition is liquid and pourable at 25° C., and wherein the composition is substantially free from VOC's.

12. A paint formulation comprising a dispersant composition according to claim 3.

13. A paint formulation comprising a dispersant composition according to claim 11.
